(19) United States
(12) Patent Application Publication
(10) Pub. No.: US 2026/0202289 A1
(43) Pub. Date: Jul. 16, 2026

(54) MOLD FOR ENCAPSULATING SAMPLES WITH MILLIMETER DIMENSIONS

(71) Applicants: Karla Maria Muñoz Alcocer, Chihuahua (MX); Ximena Maria González Muñoz, Chihuahua (MX)

(72) Inventors: Karla Maria Muñoz Alcocer, Chihuahua (MX); Ximena Maria González Muñoz, Chihuahua (MX)

(21) Appl. No.: 19/136,865

(22) PCT Filed: Nov. 27, 2023
(86) PCT No.: PCT/MX2023/050070

§ 371 Date: Jun. 7, 2025

(30) Foreign Application Priority Data
Dec. 7, 2022 (MX) MX/A/2022/015557

(51) Int. Cl. G01N 1/36

(52) U.S. Cl. CPC G01N 1/36; G01N 2001/364; G01N 2001/366; G01N 2001/368

(57) ABSTRACT

A mould for encapsulating millimetric solid samples, which has the purpose of encapsulating millimetric solid samples, in particular from, but not limited to, artistic, historical and cultural heritage assets. By observing the samples through a microscope, whether stratigraphically (layer view) or using another necessary orientation, the mould makes it possible to assess and identify the manufacturing material of such heritage assets, such as pigments, dyes, varnishes and metallic laminates. The purpose of studying stratigraphic samples is to identify the manufacturing technique used to apply layers, for example, to a sculpture or painting, and subsequent interventions (superposition of new layers) over time.

### PURPOSE OF THE INVENTION

The purpose of this invention is to create an efficient system for encapsulating samples taken from immovable property, fixtures, and movable property (objects) of historical, artistic, and/or cultural significance, or for any material intended to be studied, analyzed, diagnosed, or observed under an optical microscope of any type or brand. The study of stratigraphic samples or cross-sections, frontal sections, or any other required position for observation and diagnosis is aimed at identifying pigments, dyes, binders, varnishes, and other materials present in heritage assets of cultural, historical, or artistic significance. Stratigraphic samples allow the determination of manufacturing techniques based on the layering structure applied either at the time of production of the asset under study or added over time.

### BACKGROUND

The sample encapsulation system is widely used in laboratories and research centers both nationally and internationally. The process, materials used, and application technique depend on the type of sample to be studied and the purpose of the research or diagnosis. In the fields of medicine and biotechnology, cellular tissue encapsulation from animal, plant, and human origins is common, generally using wax or paraffin to encapsulate the sample with square or rectangular metal molds (Sadeghipour, A., & Babaheidarian, P., 2019, Tissue-Tek Embedding Center—Embedding Techniques). Patents for molds designed for this type of sample include (ES2681602T3, U.S. Pat. No. 8,609,431B2, JP6775492B2, U.S. Pat. No. 7,780,919B2, KR102148747B1, JP6228205B2, U.S. Pat. No. 10,670,593B2). Mineralogy and the study of industrial materials also make extensive use of encapsulation for samples extracted from rocks, soils, or industrial materials. Companies that sell molds and solutions for encapsulating these types of samples include Metalinespec, which distributes materials from various American and European brands in Mexico. Patents found for molds used in metallurgical or industrial sample encapsulation include MX 198536 B, U.S. Pat. No. 7,663,101B2, U.S. Pat. No. 2,996,762A, US20070166834A1.

Science Services, a company based in Germany, specializes in materials and consumables for microscopic studies, offering molds for both medical laboratories and the metallographic industry, among others. The most similar mold to the present invention is the Standard Flat Embedding Mold with 21 numbered cavity measurements (US—20.06.2013); however, the cavity sizes vary and are not proportionate to the efficiency needed for mounting samples, as will be explained in the Description of the Invention section. Additionally, companies sell silicone molds for artisanal, craft, and culinary purposes, as well as those used to make ice.

Laboratories, scientific research institutions, museums, academies, and independent specialists dedicated to the scientific study of cultural heritage—both nationally and internationally—carry out similar processes to prepare stratigraphic samples for observation under an optical microscope (Derrick, M., 1994; Gleeson, 2017).

There are several reasons why samples from heritage assets of cultural, historical, or artistic significance are encapsulated. First, these samples may be too small to handle or too delicate, with a risk that the various layers (support, ground layer, pictorial layer, and any overpainting layers) could separate when being studied. This could obstruct a complete reading and interpretation of the sample. Second, encapsulation helps preserve the microstructure of the sample along with its identification code, allowing the sample to be observed years after encapsulation while maintaining its original characteristics. Finally, encapsulation is essential for achieving an optically flat surface to facilitate focusing during microscopic examination.

The molds commonly used for encapsulating such samples are typically designed and marketed for the metallurgical industry, usually featuring large-diameter cavities (among the smallest being 20 and 25 mm in diameter) or for home use to make ice cubes. Samples for the study of cultural heritage are very small (approximately 0.5 to 4 mm in diameter) because, given their historical, artistic, and/or cultural significance, it is not feasible to obtain larger samples. Ice molds are also large relative to the size of these samples, resulting in significant resin waste, even when two samples are encapsulated in the same cavity and then separated. Additionally, this system does not allow for the inclusion of the sample's identification code in the encapsulation. The Smithsonian Institution published an article providing a two-section encapsulation system (Wachowiak, M., 2004) and a series of YouTube videos in 2011 demonstrating the process. Dr. Karla Muñoz Alcocer (co-applicant of the present patent) and Conservator Melvin Jr. Wachowiak (author of the article) collaborated on a research project between 1999 and 2006. During this period, Wachowiak developed a sample encapsulation system adapted for small samples, with the possibility of encapsulating a label alongside the sample. Later, Dr. Muñoz Alcocer innovated the process for encapsulating stratigraphic samples based on the principles established by Wachowiak, resulting in the ART-mold.100, a mold for encapsulating solid samples with millimeter dimensions. This mold allows for a more efficient and systematic encapsulation process, as will be described later.

Sadeghipour, A., & Babaheidarian, P., (2019) Making formalin-fixed, paraffin embedded blocks. Biobanking, 253-268.

Derrick, M., Souza, L., Kieslich, T., Florsheim, H., & Stulik, D. (1994). Embedding paint cross-section samples in polyester resins: problems and solutions. Journal of the American Institute for Conservation, 33(3), 227-245.

Gleeson M., Cleaning Questions and Cross-Sections Apr. 11, 2017 at The artifact Lab Conservation in Action, Penn Museum. Disponible: https://www.penn.museum/sites/artifactlab/tag/cross-sections/, Consultado: 1 octubre, 2022

Wachowiak, M. J. (2004). Efficient new methods for embedding paint and varnish samples for microscopy. Journal of the American Institute for Conservation, 43(3), 205-226

### BRIEF DESCRIPTION OF THE FIGURES

All aspects and advantages of the invention will become evident from the following detailed description of the figures:

FIG. 1 shows a top view of the standard-size embedding mold, containing 24 cavities. The two left columns correspond to half-capsule cavities, while the two right columns correspond to full-capsule cavities.

FIG. 2 shows a bottom view of the embedding mold, with the two left columns corresponding to half-capsule cavities and the two right columns corresponding to full-capsule cavities.

FIG. 3 shows a cross-sectional view of the mold.

FIG. 4 shows a flow diagram of the sample preparation process.

FIG. 5 shows the step of pouring resin into the mold during the embedding process.

FIG. 6 shows the placement of the sample within the embedding cavity along with the identification tag.

FIG. 7 shows a perspective view of a completed embedded capsule.

FIG. 8 shows examples of different-sized capsules.

FIG. 9 shows a partial sectional view of the mold, illustrating the placement of the sample within the cavity.

FIG. 10 shows the step-by-step process for creating half-capsules.

FIG. 11 shows the process of removing a full capsule from the mold.

FIG. 12 shows a comparison diagram of different sample sizes, emphasizing the importance of standardized sizing.

FIG. 13 shows a cross-sectional view during resin pouring with the sample positioned in place.

FIG. 14 shows a schematic view of the sample identification tag's position during the embedding process.

FIG. 15 shows the microscopic view of the sample, highlighting the optical flatness of the surface after embedding.

FIG. 16 shows a focus comparison diagram under an optical microscope, illustrating the difference before and after embedding.

FIG. 17 shows a system diagram for the numbering and classification of the capsules, ensuring efficient sample management and archiving.

FIG. 18 shows an example of a storage tray containing multiple capsules.

FIG. 19 shows a protective case for long-term storage of the embedded samples.

FIG. 20 shows a sample of a standardized label for the capsules, displaying the identification code and sampling information.

FIG. 21 shows a diagram of the mold cleaning steps, ensuring efficient maintenance for reuse.

FIG. 22 shows a usage scenario within a cultural heritage research environment.

FIG. 23 shows an example of the actual operation during the embedding process.

FIG. 24 shows a comparison of embedding various types of material samples, highlighting the broad applicability of the invention.

FIG. 25 shows a diagram for marking the sample's position within the capsule.

FIG. 26 shows an example diagram of microscopic layer analysis of the sample.

FIG. 27 shows an optical effect diagram of the embedded capsule under a microscope.

FIG. 28 shows a bottom-front perspective view of a complete capsule.

### DETAILED DESCRIPTION OF THE INVENTION

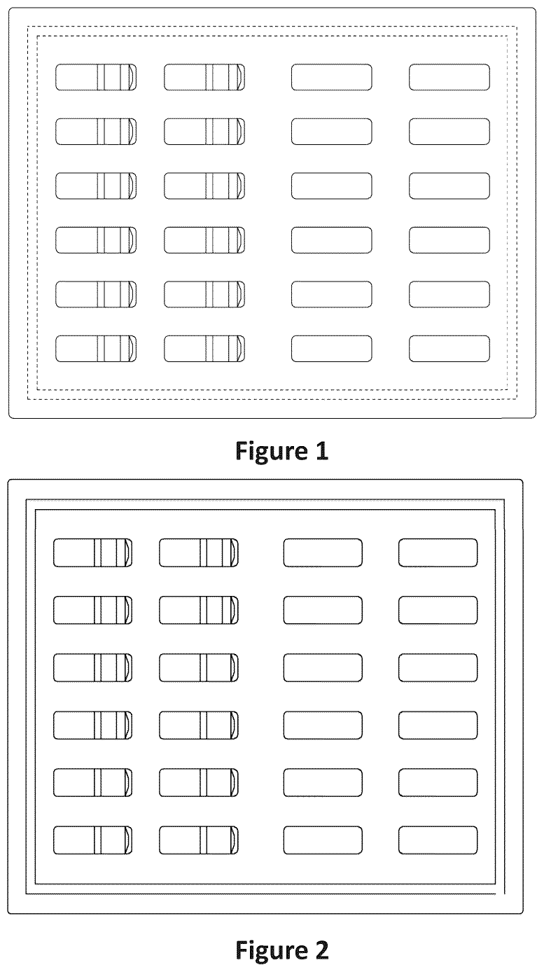

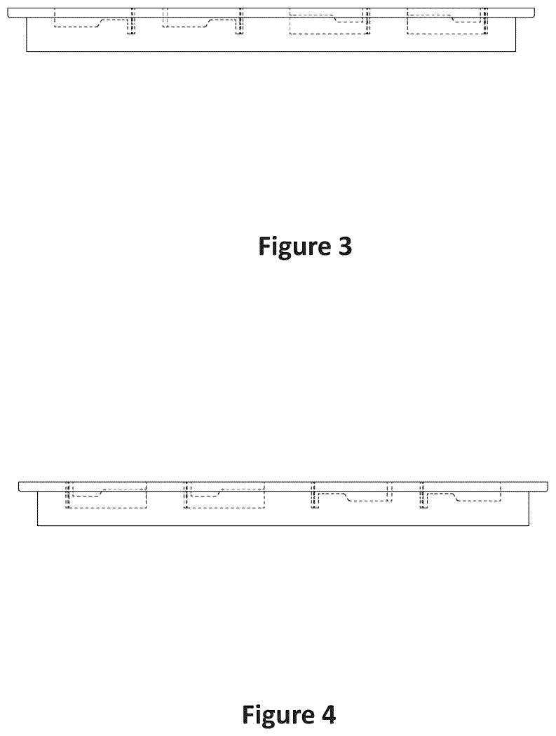

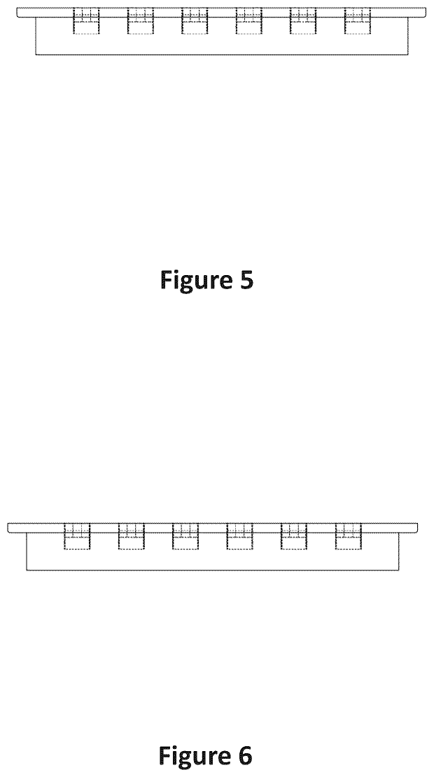

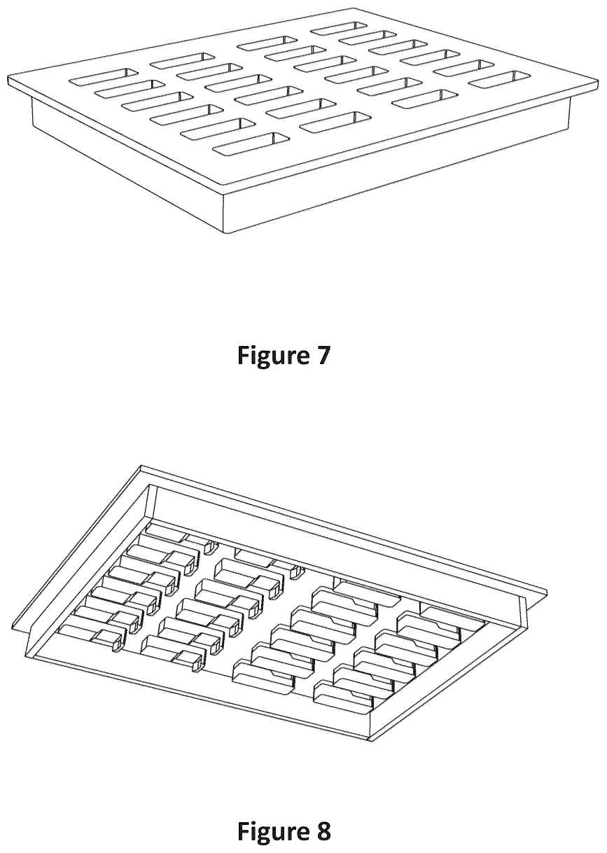

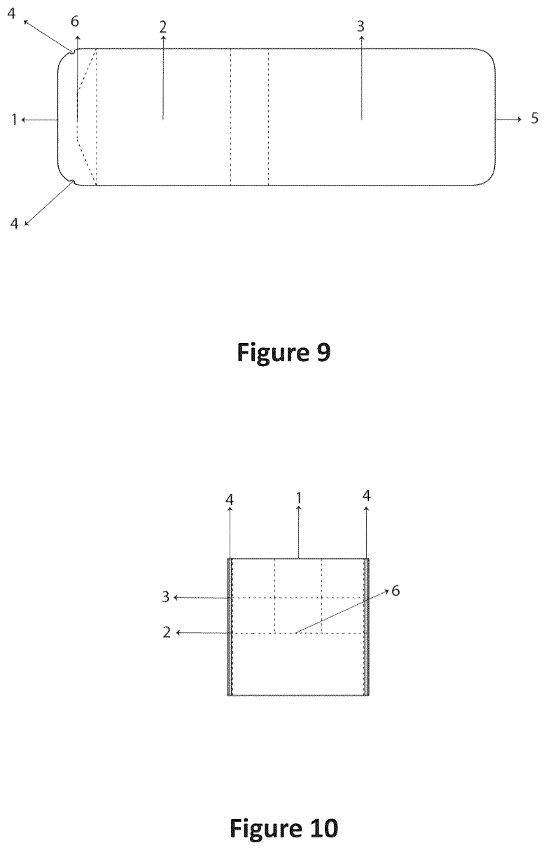

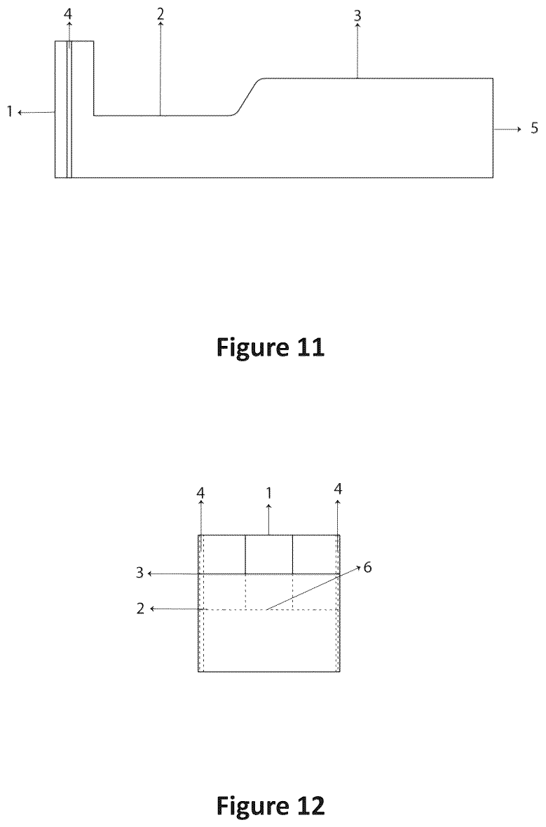

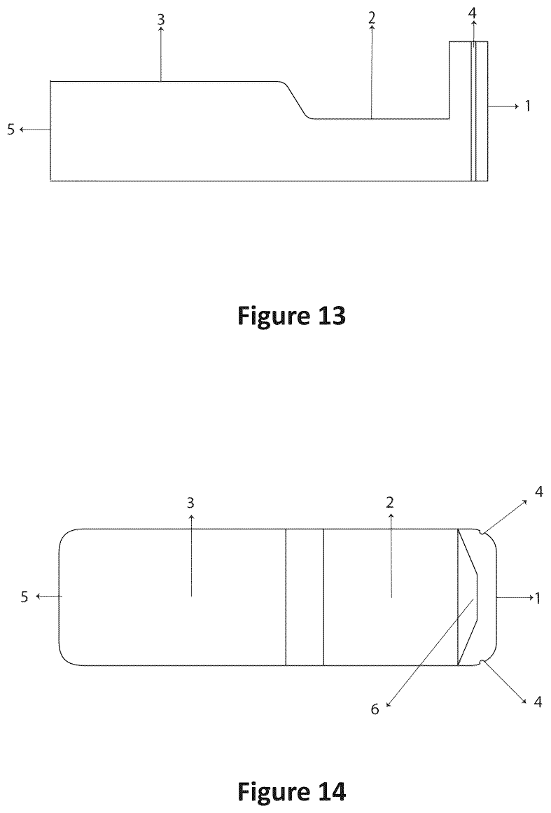

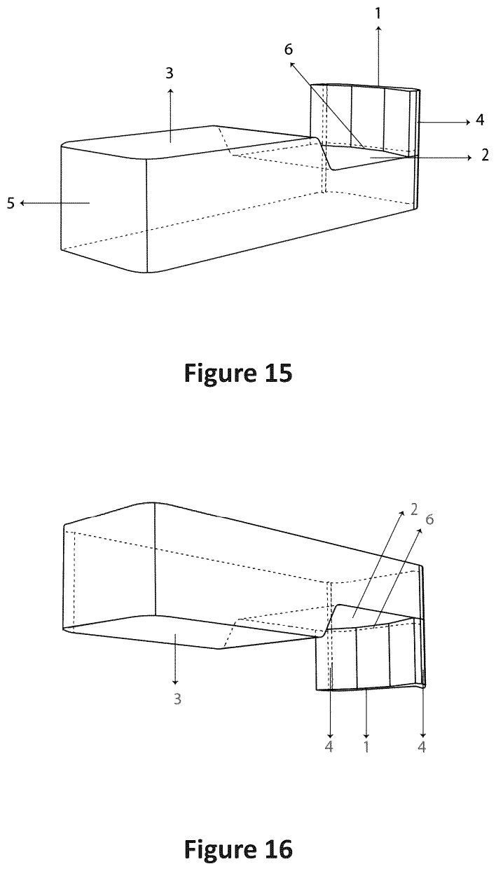

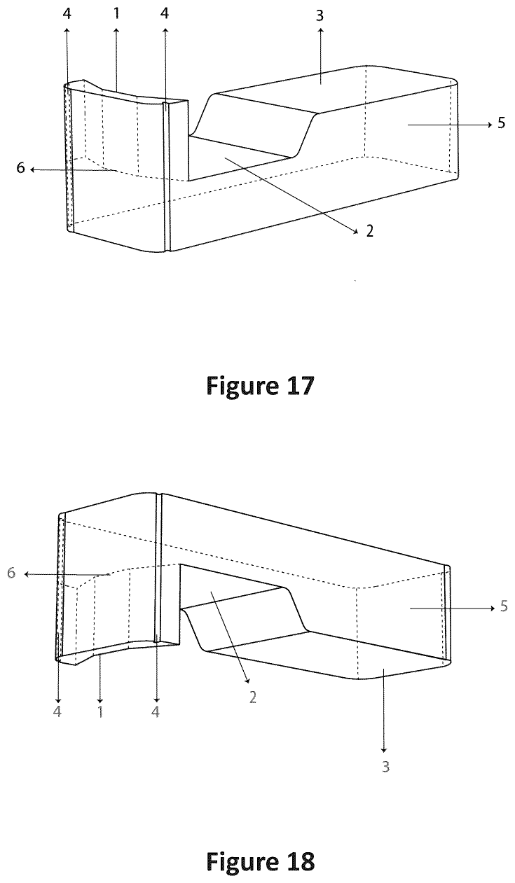

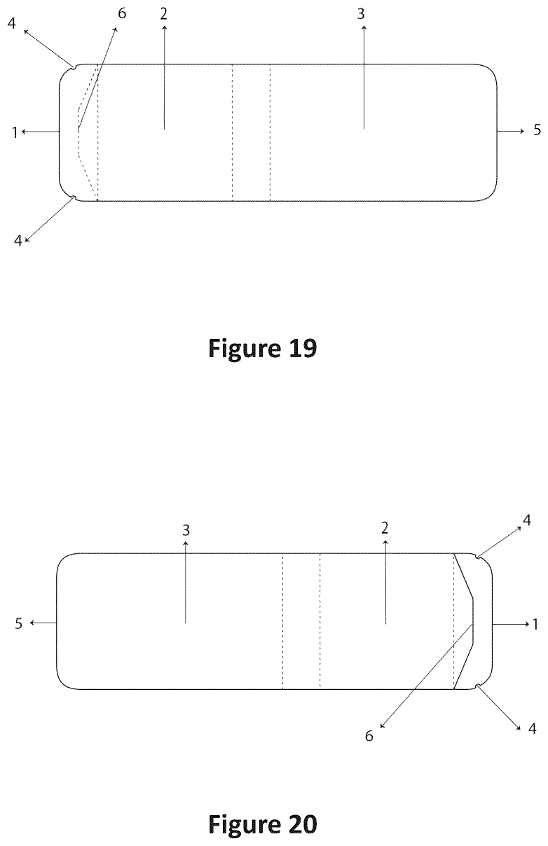

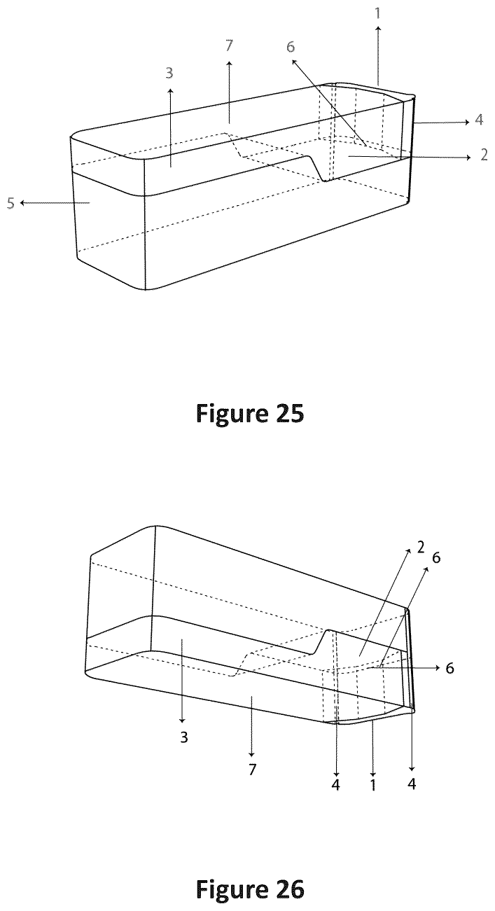

The innovation presented is a mold designed to standardize and expedite the encapsulation process of samples with millimetric dimensions (0.1 to 6.0 mm) in epoxy resin or other resinous materials (FIGS. 1-8). The silicone mold, or any other flexible material, can be used by museum laboratories, academies, cultural heritage research centers, and industries requiring the encapsulation of millimetric samples for optical microscope observation. The standard size of the mold in this invention includes 24 cavities in total: 12 cavities produce the half capsule, ART-cap.1/2 (FIGS. 9-18), where the sample (6) is placed and identified with a label attached to a flat surface (3). The other 12 cavities produce full capsules, ART-cap.1 (FIGS. 19-28). In these last cavities, the 12 prepared half-capsules with the sample are placed to be covered with resin, resulting in twelve complete rectangular capsules. Thus, the samples are fully encapsulated with their identification label.

The half-capsule, ART-cap.1/2, features a polygonal interior wall and a straight exterior wall (1), with a thickness that may vary between 0.5 and 2.0 mm. This allows for quick placement of the sample without the risk of it extending beyond the upper edge of the half-capsule. The wall also ensures the sample is placed in a centered zone (6) at a consistent distance from the upper edge of the half-capsule, allowing for a fast sanding process that can accommodate multiple samples simultaneously, without variation in sample positioning. The wall standardizes the sanding process, whether by hand or with precise millimetric cutting using an automatic cutter and/or sander, without risking sample loss from excessive sanding. Additionally, the wall (1) features a line on both sides (4) indicating the sanding limit, which enables precise observation of the sample, reducing polishing time since there is no need to constantly check the samples under the microscope, as is commonly done.

The encapsulated sample, ART-cap.1, rests on the microscope base on its flat surface (5), while the upper wall (1) remains close to the microscope objectives. This upper wall is sanded to allow a clear view of the sample under the optical microscope.

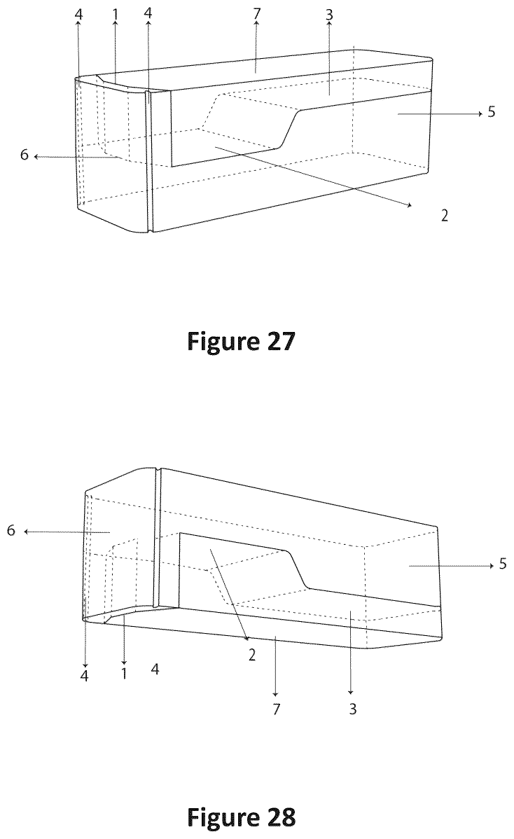

The design of the half-capsule wall (1) eliminates any joint line that could interfere with the visibility of the sample when analyzed under the microscope (FIG. 27), providing a completely edge-free viewing surface. This is an improvement over other encapsulation methods where the line created by pouring liquid resin over dry resin is visible near the sample. This innovation in the half-capsule, ART-cap.1/2, allows for faster and more efficient microscopic examination.

The encapsulation process with this innovation is as follows: using a stereoscope, the sample can be observed and manipulated on the short upper face (2) of the half-capsule, ART-cap.1/2, to position the sample against the wall (1) and secure it on the straight side of the polygonal wall (6) of the half-capsule. A label with the sample's identification code is attached to the horizontal space (3), as previously explained. This space is sized to accommodate standard-sized labels, facilitating the labeling process.

The half-capsule also includes a line (4) that marks the position of the sample, serving as a guide for the technician during sanding, indicating the limit to prevent over-sanding and the potential loss of the sample.

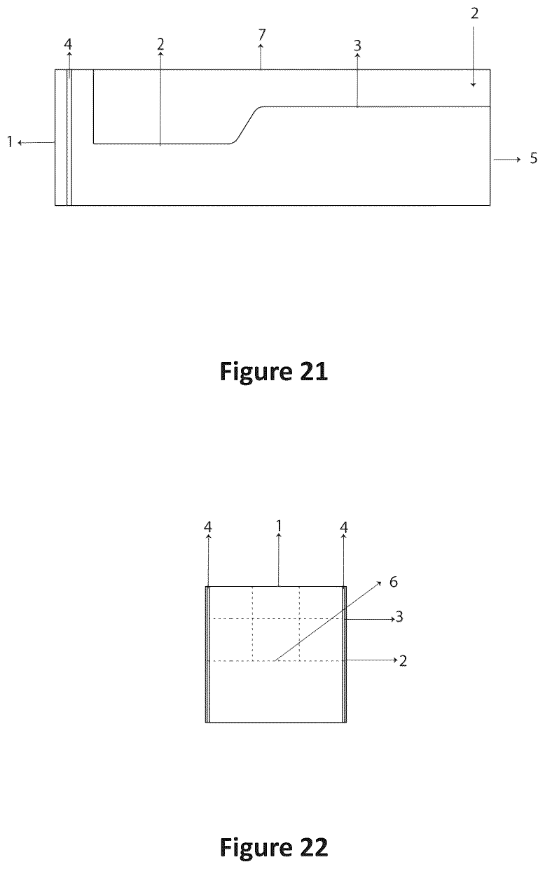

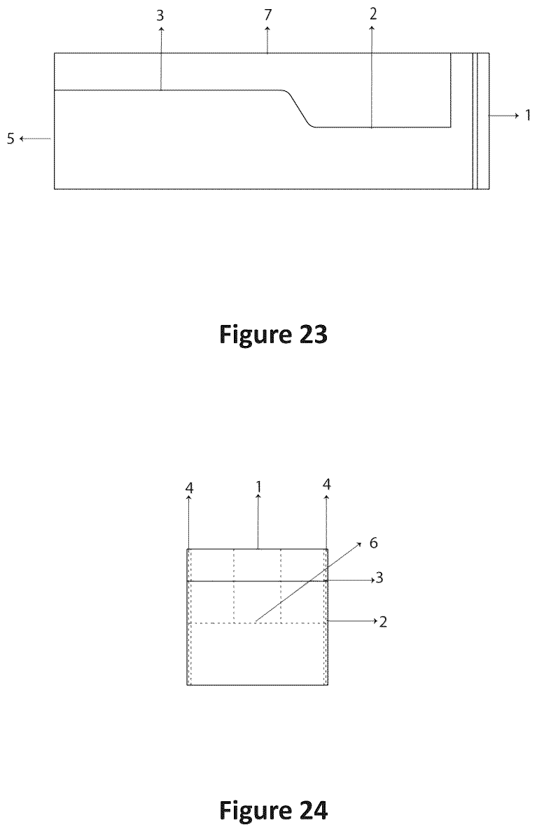

Once the twelve samples are prepared in the half-capsules, they are placed in the corresponding cavities for the full capsule, ART-cap.1, in the mold. These cavities are slightly deeper, ensuring that both the label and the sample (7) are completely covered by the new resin layer (FIGS. 21 and 23). The remaining resin is then applied again to the half-capsule cavities of the mold, so that once the resin dries, twelve samples are fully encapsulated in the complete capsules, ART-cap.1, and twelve new half-capsules, ART-cap.1/2, are available for use with other samples.

The encapsulation process enabled by the ART-mold.100 for millimetric sample dimensions is effective, straightforward, economical, environmentally efficient, and easy to perform. It is suitable for small laboratories with basic equipment as well as large laboratories that require frequent and numerous encapsulations.

Having sufficiently described the invention; we consider it novel and therefore claim as our exclusive property the content of the following claims.

1. A mold for encapsulating samples of millimeter dimensions comprising:
cavities having two different cavities, wherein each cavity that complements each other in a two stages of an encapsulation process,
wherein dimensions of the two cavities reduce an excess of a resinous material,
wherein a half of a resin capsule of the cavities called ART-cap.1/2 includes a wall (1) to standardizing positioning of the sample of millimeter dimensions on a same point (6), which allows systematizing and standardizing a position of the sample of millimeter dimensions, facilitating the sanding process, necessary to clearly visualize the sampled by an optical microscope.

2. The mold for encapsulating samples of millimeter dimensions according to with claim 1, wherein the wall includes a line (4) on both sides of the wall, wherein each one of the lines includes marking and delimit the position of the sample of millimeter dimensions, wherein the lines serve as a guide when sanding the resin capsule ART-chap.1; wherein the line is visible to the naked eye, allowing the sanding system to be faster without having to constantly check with the microscope if the sample is ready to be observed clearly in the microscope; wherein the line (4) of the wall (1) of the half capsule allows an efficient solution when sanding several samples at the same time, since on the one hand the wall (1) and the standardized placement of the samples (6) on the same point, and the line (4) that marks the position level of the sample makes the automatic sander or the process by hand constant and without interruptions, achieving the same result in all the ART-cap.1 capsules sanded at the same time.

3. The mold for encapsulating samples of millimeter dimensions according to claim 1, wherein the wall of the half capsule provides a view of the sample free of joints when placing a resin, wherein the the sample is located in the center of an union between the application of the resins in two times, or wherein the sample is placed on the capsule of solidified resin and on top of it a new liquid resin that, when it dries, the union of both resins applied in two moments is perceived.
